(19) United States
(12) Patent Application Publication
(10) Pub. No.: US 2005/0041224 A1
(43) Pub. Date: Feb. 24, 2005

(54) Apparatus and method for processing media

(76) Inventors: Roger S. Kerr, Brockport, NY (US); Seung-Ho H. Baek, Pittsford, NY (US); Thomas A. Mackin, Hamlin, NY (US); Nelson A. Blish, Rochester, NY (US)

Correspondence Address: Milton S. Sales;Patent Legal Staff, Eastman Kodak Company, 343 State Street, Rochester, NY, 14650-2201, US

(21) Appl. No.: 10/646,553

(22) Filed: Aug. 22, 2003

(51) Int. Cl. G03B 27/32

(52) U.S. Cl. 355/27

(57) ABSTRACT

An imaging apparatus (10) for exposing an image on a photosensitive media (44) utilizing microcapsules (46) with an image-forming material encapsulated within, image wise exposing desired microcapsules within the photosensitive media with a multiple channel image exposure device to harden the desired microcapsules. Applying pressure with a magnetic rupturing device (50) to the exposed photosensitive media (58) rupturing the unexposed microcapsule (40), releasing an image-forming material encapsulated within to form an image on the photosensitive media.

### FIELD OF THE INVENTION

The present invention relates in general to an image-forming apparatus and in particular to producing images by rupturing unexposed microcapsules in a photosensitive media by applying pressure with a magnetically loaded roller.

### BACKGROUND OF THE INVENTION

Image-forming apparatus that process photosensitive materials that include microcapsules containing image-forming materials are well known in the art. In this type of apparatus microcapsules are image wise exposed to radiation from an exposure device based on imaging information sent to the exposure device. The photosensitive microcapsules encapsulating the imaging material become hardened when exposed to radiation from the exposure device. Microcapsules that are not exposed by the radiation, and hence do not become hardened, are ruptured by applying pressure. The image-forming material from the ruptured microcapsules is released to begin the development of the desired image. Image-forming apparatus that employ photosensitive microencapsulated imaging materials are disclosed in U.S. Pat. Nos. 4,399,209; 4,416,966; 4,766,050; 5,783,353; and 5,916,727.

### SUMMARY OF THE INVENTION

Briefly, according to one aspect of the present invention a method for processing media comprises providing the media with microcapsules. A first group of microcapsules is exposed. A first magnetic roller is segmented into alternate north/south magnetic sections. A second magnetic roller is segmented into alternate north/south segments wherein the north/south segments on the first roller are of an opposite polarity of the magnetic section on the second roller. Flanges are on opposite ends of each of the first and second magnetic rollers. The media passes between the first and second magnetic roller wherein a force of attraction between the magnetic sections ruptures unexposed microcapsules in the media.

The present invention is intended to improve the performance of an imaging apparatus generates an image within a photosensitive media having a plurality of microcapsules with an image-forming material encapsulated within the microcapsules. When image wise exposed by an exposure device desired microcapsules become hardened to a point that when processed by a magnetic microcapsule rupturing device, the hardened exposed microcapsules remain intact while the unexposed microcapsules are ruptured and release an image-forming material to form an image within the photosensitive media.

According to one aspect of the present invention, a pair of magnetic rollers having radially north/south (N/S) charged polls to provide a processing nip to rupture capsules.

The invention its objects and advantages will become more apparent in the detailed description of the preferred embodiment presented below.

### BRIEF DESCRIPTION OF THE DRAWINGS

A more complete understanding of the invention and its advantages will become apparent from the detailed description taken in conjunction with the accompanying drawings, wherein examples of the invention are shown, and identical reference numbers have been used, where possible, to designate identical elements that are common to the figures referenced below:

FIG. 1 is a schematic, cross sectional view of an imaging apparatus according to the present invention;

FIG. 2 is a schematic, cross sectional view of an image exposure device used in the imaging apparatus shown in FIG. 1;

FIG. 3 shows two magnetically segmented rupturing rollers according to the present invention;

FIG. 4 shows a side view of the magnetic rupturing rollers shown in FIG. 3;

FIG. 5 shows a magnetically segmented rupturing roller and a ferrous rupturing roller according to the present invention;

FIG. 6 shows two magnetic rupturing rollers according to the present invention;

FIG. 7 shows a magnetically segmented rupturing roller with a ferrous load plate according to the present invention;

FIG. 8 shows ferrous rupturing roller with segmented load magnet according to the present invention;

FIG. 9 shows another embodiment of the present invention using a ferrous rupturing roller and magnetic load bar suitable for multi-pass rupturing according to the present invention; and

FIG. 10 shows ferrous rupturing ball and magnetic load bar suitable for multi-pass rupturing according to the present invention.

### DETAILED DESCRIPTION OF THE INVENTION

The present invention will be directed in particular to elements forming part of, or in cooperation more directly with an apparatus in accordance with the present invention. It is to be understood that elements not specifically shown or described may take various forms well known to those skilled in the art.

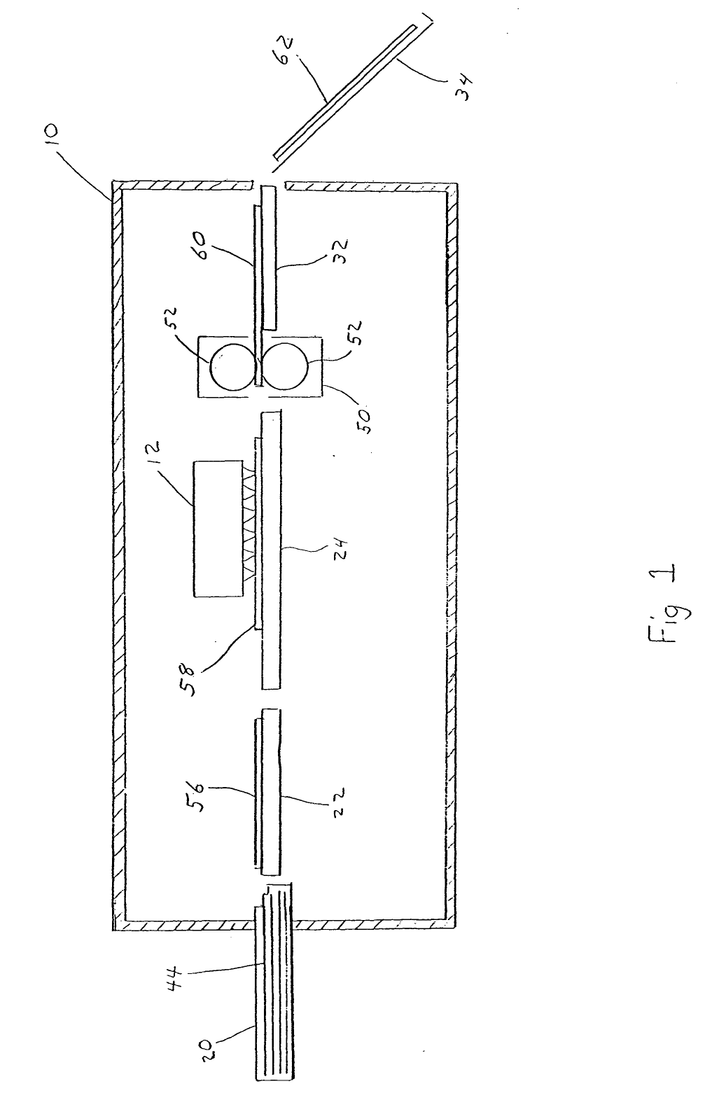

Referring now to FIG. 1 a schematic, cross sectional view of an imaging apparatus 10 for exposing photosensitive media 44 utilizing an image exposure device 12 is shown. Photosensitive media 44 is removed from media tray 20 to the preheat station 22. Once the preheat step is complete the preheated photosensitive media 56 proceeds to the exposure station 24 to be image wise exposed by image exposure device 12. The exposed photosensitive media 58 is then passed through the microcapsule rupturing device 50 where pressure is applied by magnetic rupturing rollers 52. The developed photosensitive media 60 is then passed to the post heating station 32 and from there to the media exit tray 34 as competed image 62.

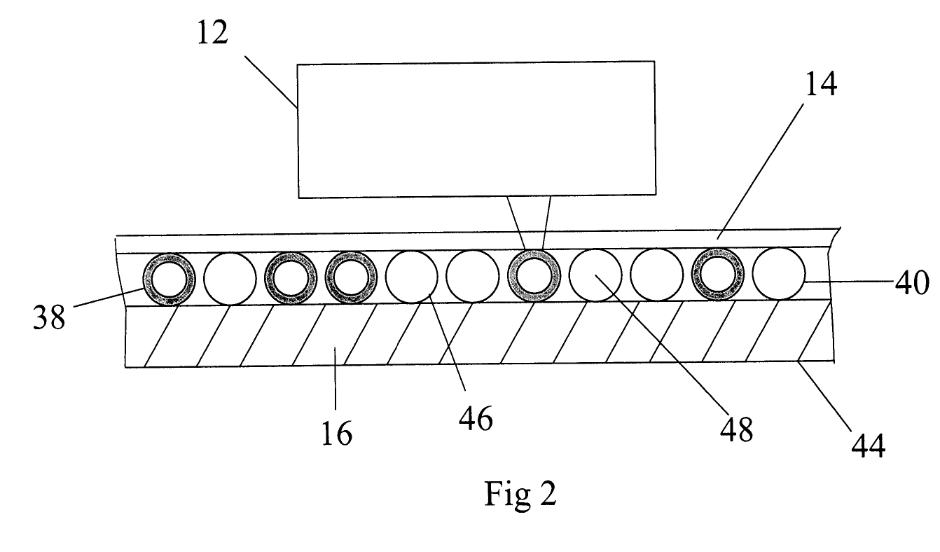

FIG. 2 shows a schematic, cross sectional view of image exposure device 12 shown in FIG. 1. Image exposure device 12 exposes photosensitive media 44, which has a plurality of microcapsules 46 with an image-forming material 48 encapsulated within the microcapsules 46. The microcapsules are coated on support base 16 and have an overcoat 14. Image wise exposure of the selected microcapsules 46 hardens microcapsules 46. Exposed microcapsules 38 when processed through a microcapsule rupturing device 50 that utilizes magnetic rupturing roller 52, shown in FIG. 1, are not ruptured. The unexposed microcapsules 46 are ruptured releasing image-forming material 48 encapsulated within the unexposed microcapsules 40 to form an image within the photosensitive media 44.

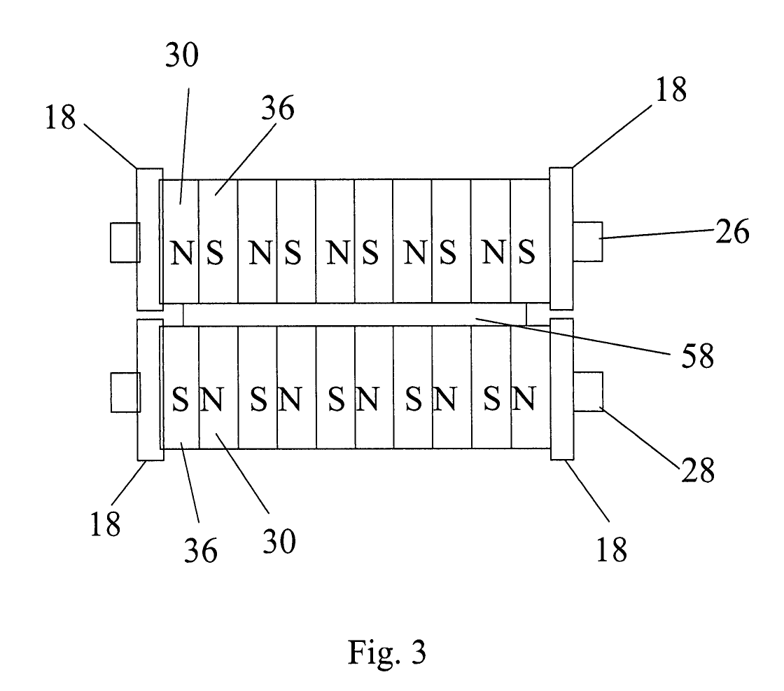

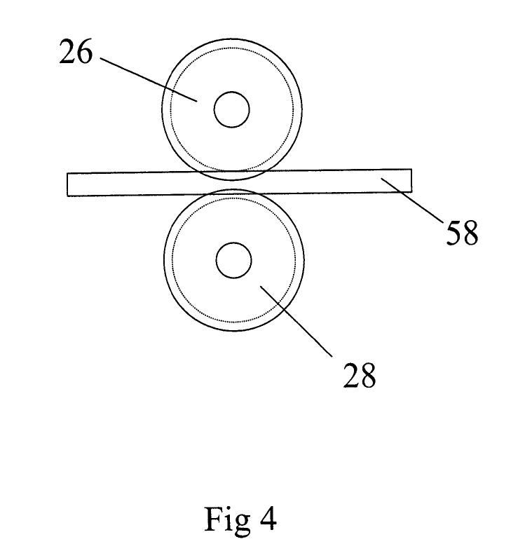

FIGS. 3 and 4 show first magnetically segmented rupturing roller 26 and second magnetically segmented rupturing roller 28, with exposed photosensitive media 58 between the first magnetically segmented rupturing roller 26 and second magnetically segmented rupturing roller 28. First magnetically segmented rupturing roller 26 and second magnetically segmented rupturing roller 28 have alternating north magnetic segments 30 and south magnetic segments 36. The polarization pattern of north magnetic segments 30 and south magnetic segments 36 on the first magnetically segmented rupturing roller 26 are opposite the polarizations pattern on the second magnetically segmented rupturing roller 28. This creates a force of attraction between first magnetically segmented rupturing roller 26 and second magnetically segmented rupturing roller 28, which ruptures any unexposed microcapsules 40 within exposed photosensitive media 58, releasing image-forming material with the photosensitive media 44.

Entrance flange 18 on both ends of the first magnetically segmented rupturing roller 26 and second magnetically segmented rupturing roller 28, maintain a fixed distance between the magnetic portions of the first magnetically segmented rupturing roller 26 and second magnetically segmented rupturing roller 28. This fixed distance is necessary so that exposed photosensitive media 58 is allowed to pass between the first magnetically segmented rupturing roller 26 and second magnetically segmented rupturing roller 28 since the attraction force between the first magnetically segmented rupturing roller 26 and second magnetically segmented rupturing roller 28 would make it difficult to separate the surfaces of the first magnetically segmented rupturing roller 26 and second magnetically segmented rupturing roller 28 if they were allowed to contact each other with no exposed photosensitive media 58 present.

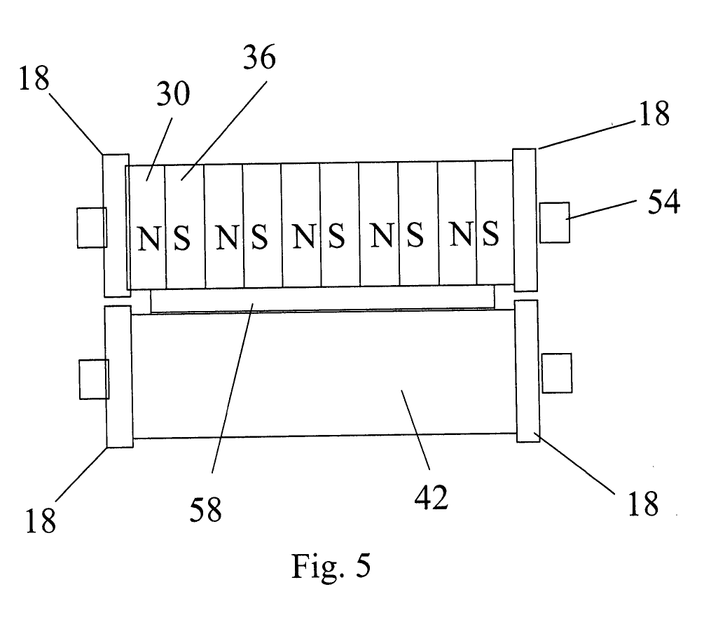

FIG. 5 shows a magnetically segmented rupturing roller 54 and a ferrous rupturing roller 42 with exposed photosensitive media 58 between the magnetically segmented rupturing roller 54 and a ferrous rupturing roller 42. The magnetically segmented rupturing roller 54 has alternating north magnetic segments 30 and south magnetic segments 36. This creates a force of attraction between the magnetically segmented rupturing roller 54 and the ferrous rupturing roller 42, which ruptures any unexposed microcapsules 40 within exposed photosensitive media 58, as exposed photosensitive media 58 passes between the magnetically segmented rupturing roller 54 and the ferrous rupturing roller 42. The ruptured microcapsules release image-forming material 48 encapsulated within the unexposed microcapsules 40 to form an image within the photosensitive media 44.

Entrance flange 18 on both ends of the magnetically segmented rupturing roller 54 and the ferrous rupturing roller 42, maintain a fixed distance between the magnetically segmented rupturing roller 54 and the ferrous rupturing roller 42. This is necessary so that exposed photosensitive media 58 is allowed to pass between the magnetically segmented rupturing roller 54 and the ferrous rupturing roller 42 since the attraction force between the magnetically segmented rupturing roller 54 and the ferrous rupturing roller 42 would make it difficult to separate the surfaces of the magnetically segmented rupturing roller 54 and the ferrous rupturing roller 42 if they were allowed to contact each other with no exposed photosensitive media 58 present.

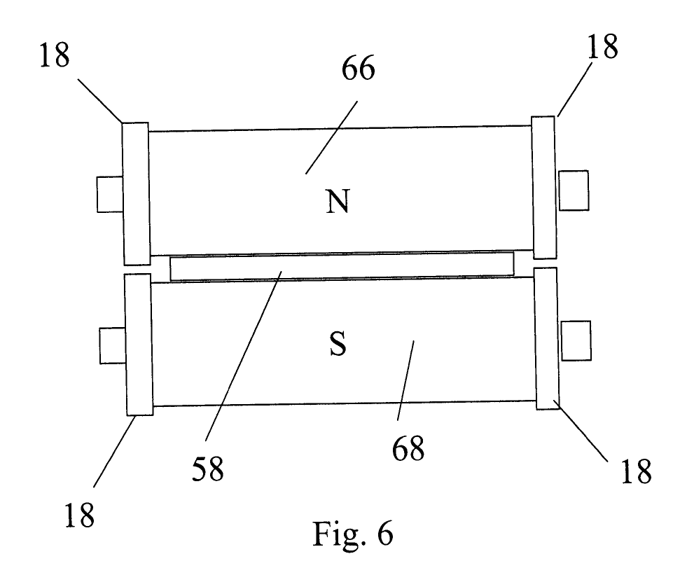

FIG. 6 shows a first magnetic rupturing roller 66 and a second magnetic rupturing roller 68 with exposed photosensitive media 58 between the first magnetic rupturing roller 66 and the second magnetic rupturing roller 68. The first magnetic rupturing roller 66 and the second magnetic rupturing roller 68 are oppositely charged north and south. This creates a force of attraction between the first magnetic rupturing roller 66 and the second magnetic rupturing roller 68, which ruptures any unexposed microcapsules 40 within exposed photosensitive media 58 as exposed photosensitive media 58 passes between the first magnetic rupturing roller 66 and the second magnetic rupturing roller 68 the ruptured microcapsules release image-forming material 48 encapsulated within the unexposed microcapsules 40 to form an image within the photosensitive media 44.

Entrance flange 18 on both ends of the first magnetic rupturing roller 66 and the second magnetic rupturing roller 68, maintain a fixed distance between the first magnetic rupturing roller 66 and the second magnetic rupturing roller 68. This is necessary so that exposed photosensitive media 58 is allowed to pass between the first magnetic rupturing roller 66 and the second magnetic rupturing roller 68 since the attraction force between the first magnetic rupturing roller 66 and the second magnetic rupturing roller 68 would make it difficult to separate the surfaces of the first magnetic rupturing roller 66 and the second magnetic rupturing roller 68 if they were allowed to contact each other with no exposed photosensitive media 58 present.

Although the embodiments shown thus far have used permanent magnets, electromagnets have some advantages in certain situations. For example, electro-magnets allow the amount of force exerted on exposed photosensitive media 58 to be varied. This may be necessary as changes are made at the factory to alter or enhance the materials used for the microcapsules contained in exposed photosensitive media 58. Using electromagnetic rollers and electromagnetic device to exert pressure on the media also eliminates the need for flanges at each end of the roller. The pressure on the media can be varied with the electromagnetic devices to exert the proper pressure to crush the unexposed microcapsules 40 and the electromagnets could be deenergized to force the rollers apart when new media is loaded. Also, the field on one of the rollers or both of the rollers could be reversed to electro-magnetically force the rollers apart.

The permanent magnets described in the present invention may be made of a number of different materials known in the art including rare-earth elements. For example, a permanent magnet may be made of a rare-earth material such as neodymium-iron-boron (NdFeB).

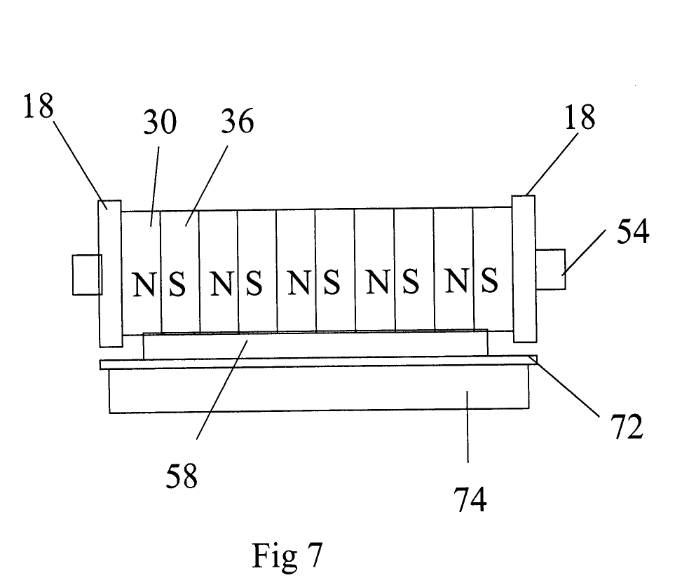

FIG. 7 shows a magnetically segmented rupturing roller 54 skid plate 72 and a ferrous load bar 74 with exposed photosensitive media 58 between the magnetically segmented rupturing roller 54 and the skid plate 72. The magnetically segmented rupturing roller 54 has alternating north magnetic segments 30 and south magnetic segments 36. This creates a force of attraction between the magnetically segmented rupturing roller 54 and the ferrous load bar 74, which ruptures any unexposed microcapsules 40 within exposed photosensitive media 58 as exposed photosensitive media 58 passes between the magnetically segmented rupturing roller 54, skid plate 72, and ferrous load bar 74. The ruptured microcapsules release image-forming material 48 encapsulated within the unexposed microcapsules 40 to form an image within the photosensitive media 44.

Entrance flange 18 on both ends of the magnetically segmented rupturing roller 54, maintain a fixed distance between the magnetically segmented rupturing roller 54 and the skid plate 72. This is necessary so that exposed photosensitive media 58 is allowed to pass between the magnetically segmented rupturing roller 54 and the skid plate 72 since the attraction force between the magnetically segmented rupturing roller 54 and the ferrous load bar 74 would make it difficult to separate the surfaces of the magnetically segmented rupturing roller 54 and the skid plate 72 if they were allowed to contact each other with no exposed photosensitive media 58 present.

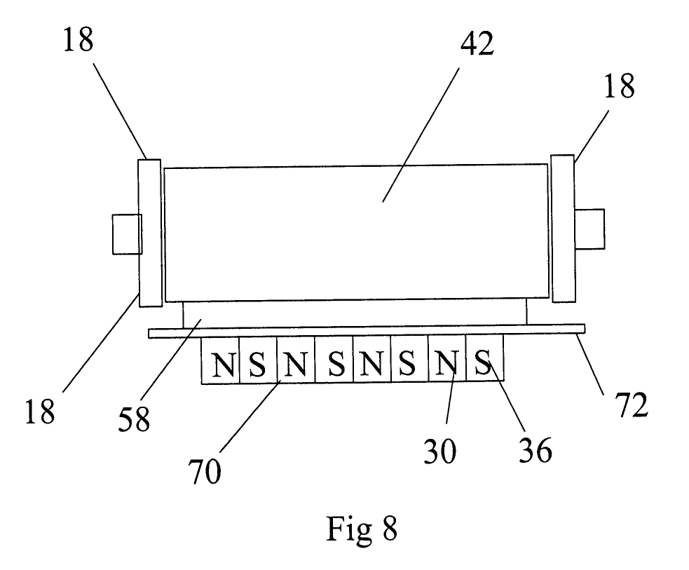

FIG. 8 shows a ferrous rupturing roller 42, skid plate 72, and a segmented bar magnet 70 with exposed photosensitive media 58 between the ferrous rupturing roller 42 and the skid plate 72. The segmented bar magnet 70 has alternating north magnetic segments 30 and south magnetic segments 36. This creates a force of attraction between the ferrous rupturing roller 42 and the segmented bar magnet 70, which ruptures any unexposed microcapsules 40 within exposed photosensitive media 58 as exposed photosensitive media 58 passes between the ferrous rupturing roller 42, skid plate 72, and segmented bar magnet 70. The ruptured microcapsules release image-forming material 48 encapsulated within the unexposed microcapsules 40 to form an image within the photosensitive media 44.

Entrance flange 18 on both ends of the ferrous rupturing roller 42 maintain a fixed distance between the ferrous rupturing roller 42 and the skid plate 72. This is necessary so that exposed photosensitive media 58 is allowed to pass between the ferrous rupturing roller 42 and the skid plate 72 since the attraction force between the ferrous rupturing roller 42 and the segmented bar magnet 70 would make it difficult to separate the surfaces of the ferrous rupturing roller 42 and the skid plate 72 if they were allowed to contact each other with no exposed photosensitive media 58 present.

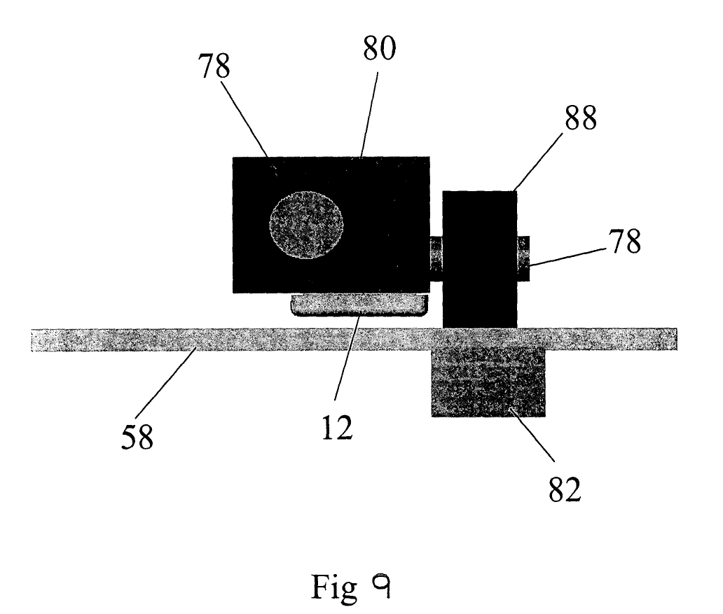

FIG. 9 shows an image exposure device 12 mounted on mounting block 80 that translates along translation shaft 78, ferrous rupturing roller 88 rides on translation shaft 78 as the image exposure device 12 is translated along translation shaft 78 while exposing photosensitive media 58 and is attracted to magnetic bar 82. Magnetic bar 82 creates a force of attraction between the ferrous rupturing roller 88 and magnetic bar 82, which ruptures any unexposed microcapsules 40 within exposed photosensitive media 58 as exposed photosensitive media 58 passes between the ferrous rupturing roller 88 and magnetic bar 82 releasing image-forming material 48 encapsulated within the unexposed microcapsules 40 to form an image within the photosensitive media 44. In operation, media 58 is translated left to right while image exposure device 12 and rupturing roller 88 are located at a position off the media. The media then comes to a stop and image exposure device 12 and rupturing roller 88 are translated along translation shaft 78 to expose a new swath of media and rupture unexposed microcapsules with rupturing roller 88.

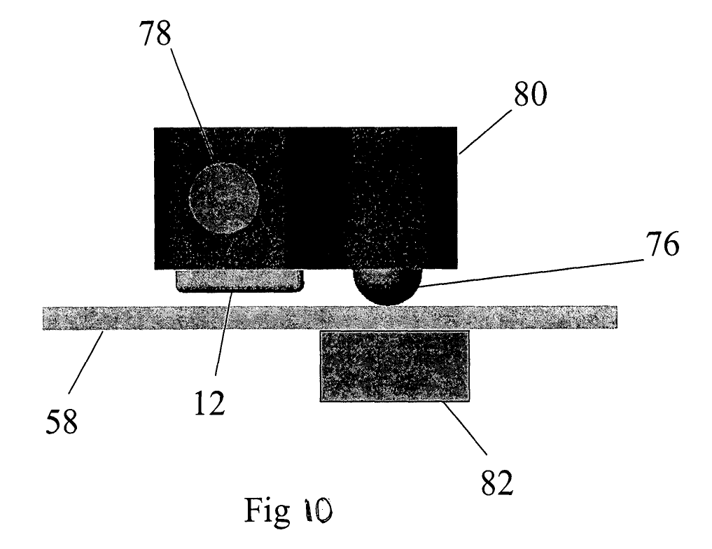

FIG. 10 shows an image exposure device 12 mounted on mounting block 80 that translates along translation shaft 78, ferrous rupturing ball 76 rides on exposed photosensitive media 58 as the image exposure device 12 is translated along translation shaft 78 while exposing photosensitive media 58 and is attracted to magnetic bar 82. Magnetic bar 82 creates a force of attraction between the ferrous rupturing ball 76 and magnetic bar 82, which ruptures any unexposed microcapsules 40 within exposed photosensitive media 58 as exposed photosensitive media 58 passes between the ferrous rupturing ball 76 and magnetic bar 82 releasing image-forming material 48 encapsulated within the unexposed microcapsules 40 to form an image within the photosensitive media 44.

The invention has been described in detail with particular reference to certain preferred embodiments thereof, but it will be understood that variations and modifications can be effected within the scope of the invention.

| | |
|---|---|
| 10. | Imaging apparatus |
| 12. | Image exposure device |
| 14. | Overcoat |
| 16. | Support base |
| 18. | Entrance flange |
| 20. | Media tray |
| 22. | Preheat station |
| 24. | Exposure station |
| 26. | First magnetically segmented rupturing roller |
| 28. | Second magnetically segmented rupturing roller |
| 30. | North magnetic segment |
| 32. | Post heating station |
| 34. | Media exit tray |
| 36. | South magnetic segment |
| 38. | Exposed microcapsule |
| 40. | Unexposed microcapsule |
| 42. | Ferrous rupturing roller |
| 44. | Photosensitive media |
| 46. | Microcapsule |
| 48. | Image-forming material |
| 50. | Microcapsule rupturing device |
| 52. | Magnetic rupturing roller |
| 54. | Magnetically segmented rupturing roller |
| 56. | Preheated photosensitive media |
| 58. | Exposed photosensitive media |
| 60. | Developed photosensitive media |
| 62. | Completed image |
| 66. | First magnetic rupturing roller |
| 68. | Second magnetic rupturing roller |
| 70. | Segmented bar magnet |
| 72. | Skid plate |
| 74. | Ferrous load bar |
| 76. | Ferrous rupturing ball |
| 78. | Translation shaft |
| 80. | Mounting block |
| 82. | Magnetic bar |
| 84. | Mounting shaft |
| 88. | Ferrous rupturing roller |

1. A method for processing media comprising the steps of:
providing a media with microcapsules;
exposing selected microcapsules;
providing a first magnetic roller segmented into alternate north/south magnetic sections;
providing a second magnetic roller segmented into alternate north/south segments wherein said north/south segments on said first roller are of an opposite polarity of said magnetic sections on said second roller;
providing flanges on opposite ends of each of said first and said second magnetic rollers; and
passing said media between said first and said second magnetic roller wherein a force of attraction between said magnetic sections ruptures unexposed microcapsules in said media.

2. A method as in claim 1 wherein said flanges maintain said first magnetic roller and said second magnetic roller at a fixed distance sufficient to rupture unexposed microcapsules.

3. A method as in claim 2 wherein said fixed distance is great enough to ensure that said exposed microcapsules are not ruptured by pressure caused by said force of attraction.

4. An apparatus for processing media comprised of exposed microcapsules and unexposed microcapsules comprising:
a first magnetic roller wherein said first magnetic roller is segmented into alternate north/south segments;
a second magnetic roller segmented into alternate north/south segments;
wherein said north/south segments of said first roller and said north/south segments of said second roller are arranged such that a north segment on said first roller faces a south segment on said second roller; and
flanges on opposite ends of each of said first and second magnetic rollers.

5. An apparatus as in claim 4 wherein said first and second roller provide pressure on said media based on mutual magnetic attraction sufficient to rupture said unexposed microcapsules.

6. An apparatus as in claim 5 wherein said flanges maintain a fixed distance between said first and second roller sufficient to rupture said unexposed microcapsules while passing said exposed microcapsules between said rollers without rupturing.

7. An apparatus for processing media containing exposed microcapsules and unexposed microcapsules comprising:
a first magnetic roller segmented into alternating north/south magnetic segments;
a second roller magnetically attracted to said first roller;
flanges on opposite ends of said first roller and said second roller; and
wherein said flanges maintain a fixed distance between said rollers sufficient for rupturing said unexposed microcapsules while passing said exposed microcapsules intact.

8. An apparatus as in claim 7 wherein said second magnetic roller is a cylinder of ferrous magnetic material.

9. An apparatus for processing media comprised of exposed microcapsules and unexposed microcapsules comprising:
a first magnetic roller;
a second magnetic device; and
wherein magnetic attraction between said first magnetic roller and said second magnetic device creates a pressure on said media sufficient to rupture said unexposed microcapsules without rupturing said exposed micro capsules.

10. An apparatus as in claim 9 wherein a skid plate is located between said second magnetic device and said media.

11. An apparatus as in claim 9 wherein said second magnetic device is a ferrous load ball.

12. An apparatus as in claim 9 wherein said second magnetic device is a magnetic roller.

13. An apparatus as in claim 10 wherein said first magnetic roller and said second magnetic device are electromagnetic devices.

14. An apparatus as in claim 13 wherein a polarity on said magnets are reversed to unload said media.

15. An apparatus as in claim 13 wherein the magnetism on said first magnetic roller and said second magnetic device are adjusted to provide pressure sufficient to rupture said unexposed microcapsules.

16. An apparatus as in claim 15 wherein said magnets are rare earth-elements.

17. An apparatus for processing media comprised of exposed microcapsules and unexposed microcapsules comprising:
a ferrous rupturing roller;
a bar magnet; and
wherein magnetic attraction between said ferrous rupturing roller and said bar magnet creates a pressure on said media sufficient to rupture said unexposed microcapsules without rupturing said exposed microcapsules.

18. An apparatus as in claim 17 wherein said bar magnet is segmented with alternating north/south polarity.

19. A method for creating an image in a media comprised of microcapsules comprising:
translating said media a predetermined distance;
stopping transport of said media;
moving a rupturing roller and imaging exposure device laterally across said media to expose selected microcapsules with said image exposure device and rupture unexposed microcapsules;
stopping lateral translation of said rupturing roller and said image exposure device at a position to a side of said media;
transporting said media an additional predetermined distance; and
stopping transport of said media.

20. A method as in claim 19 wherein said rupturing roller is magnetically attracted to a device on an opposite side of said media.

21. A method as in claim 19 wherein said rupturing roller is a ferrous rupturing ball.
